(19) United States
(12) Patent Application Publication
(10) Pub. No.: US 2014/0087704 A1
(43) Pub. Date: Mar. 27, 2014

(54) BLOCKING INCOMING COMMUNICATION INTERRUPTIONS

(71) Applicant: International Business Machines Corporation, (US)

(72) Inventors: Michael DeCesaris, Carrboro, NC (US); William M. Megarity, Roxboro, NC (US); Luke D. Remis, Raleigh, NC (US); Gregory D. Sellman, Morrisville, NC (US)

(73) Assignee: INTERNATIONAL BUSINESS MACHINES CORPORATION, Armonk, NY (US)

(21) Appl. No.: 13/628,717

(22) Filed: Sep. 27, 2012

(51) Int. Cl. H04W 4/00

(52) U.S. Cl. 455/416

(57) ABSTRACT

Embodiments of the present invention provide a system, method, and program product for blocking an alert of an incoming communication external to an in-progress conference call which includes telecommunication devices connected to a communications network. A telecommunication device determines that the device is party to a conference call. The telecommunication device receives an incoming communication external to the conference call while it is party to the conference call. The telecommunication device blocks an alert of the incoming communication, so as to avoid interruption of the conference call. The telecommunication device determines that the conference call has concluded and the telecommunication device presents the blocked alert.

### FIELD OF THE INVENTION

The present invention relates generally to blocking communication interruptions, and more particularly to blocking interruptions while participating on a telephone conference call.

### BACKGROUND

Advancements in telephone technology provide users with multiple means of communications. In addition to placing a telephone call, users can communicate with others by sending text messages, emails from the cell phones, or use short range intercom capabilities. Although such options provide users with situation specific alternatives, the options can also serve to increase inappropriate interruptions and distract users engaged in active communications.

Contemporary phones, and particularly “smart (cell) phones” offer the ability to send and receive voice telephone calls, text messages or SMS (Short Message Service) messages, emails, intercom voice calls, call waiting alerts, caller ID, message waiting, alarms, timers, and other notifications and communications from other users or a variety of applications that can operate on smart phones.

Communications, such as calls, messages, emails, alerts, alarms and services typically provide notification to the user by an audible sound, visual display or by a persistent vibration if a device has and is set to a “silent” mode, or any combination of notification. Users that are engaged in normal telephone conversation calls can often ignore these notifications or they can politely ask the other party if they could wait while they respond or silence the notification. In the case of users engaged in a conference call, the options may be significantly reduced. In situations in which a user is engaged in a conference call in which the other participants are fellow workers of an important assignment, clients, customers, instructors and/or students of a training class, or corporate executives, politely excusing the interruption may not be acceptable and attending to some other communication notification may produce negative consequences. Equally unacceptable is the condition of the user receiving the interrupting alerts while trying to focus on an important conference call. Applications that send alarms or notifications will do so regardless of the current activity of the receiving telecommunication device and other users have no indication that the telecommunication device they attempt to contact is connected to an important and “not to be interrupted” conference call.

Users encountering these situations are faced with trying to ignore notification interruptions and focus on what is being said or what they need to say, while distractions continue. In some cases, well-meaning friends or associates may use excessive means to contact a user to obtain a response, oblivious to the fact that important or even a critical discussion is potentially being affected and the user in question is being distracted and experiences distress.

### SUMMARY

Embodiments of the present invention provide a system, method, and program product for blocking an alert of an incoming communication external to an in-progress conference call, which include telecommunication devices connected to a communications network. A telecommunication device determines that the device is party to a conference call. The telecommunication device receives an incoming communication external to the conference call while it is party to the conference call. The telecommunication device blocks an alert of the incoming communication, to avoid interruption of the conference call. The telecommunication device determines that the conference call has concluded and the telecommunication device presents the blocked alert.

In certain embodiments, the telecommunication device determines that the conference call has concluded by detecting fewer than three unique voices on the conference call. In other embodiments the telecommunication device determines that the telecommunication device is party to the conference call by identifying three or more unique voices on the conference call or by identifying one or more keywords that indicate the telecommunication device is party to the conference call, or yet further by the telecommunication device receiving manual input of being party to a conference call.

In other embodiments, the telecommunication device receives an incoming communication external to the conference call while the telecommunication device is party to the conference call and identifies an allowable incoming communication alert from an allowable alert list and receives the allowable incoming communication alert.

### BRIEF DESCRIPTION OF THE SEVERAL VIEWS OF THE DRAWINGS

FIG. 1 is a functional block diagram of a distributed communications environment in accordance with an embodiment of the present invention.

FIG. 2 is a block diagram of program modules of a telecommunication device in accordance with an embodiment of the present invention.

FIG. 3 is a flowchart depicting the steps of a program to block incoming communication alert interruptions in accordance with an embodiment of the present invention.

FIG. 4 is an exploded view of network and telecommunication devices in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

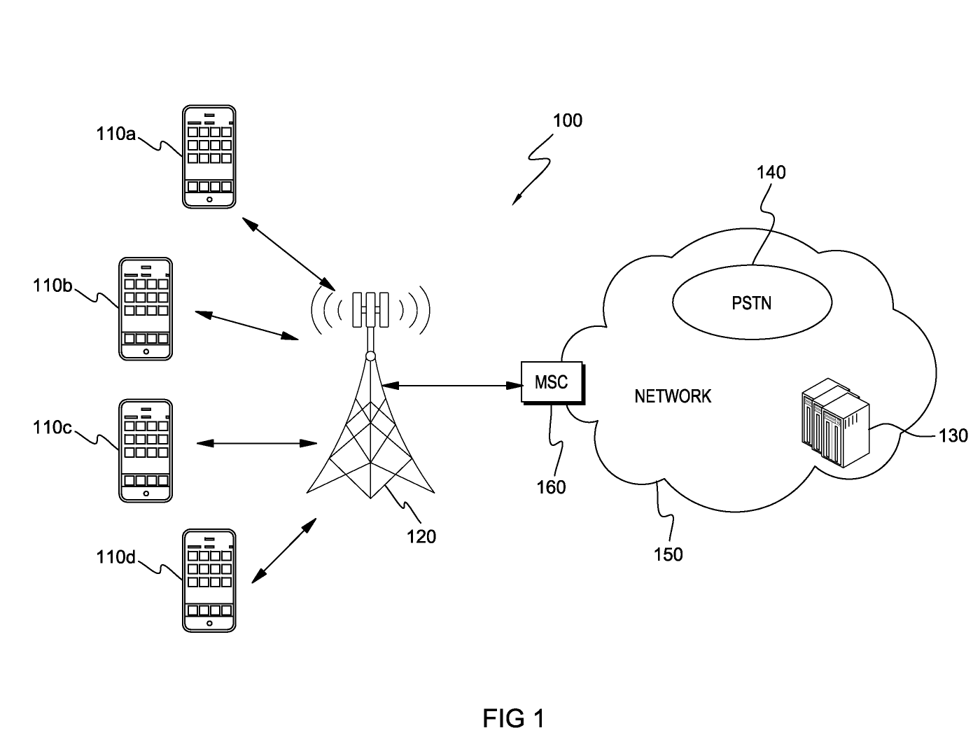

The present invention will now be described in detail with reference to the Figures. FIG. 1 is a functional block diagram illustrating a distributed communications environment, generally designated 100, including multiple telecommunication devices that are capable of processing programmable instructions and enabling devices that support the transmission and propagation of communications, in accordance with an embodiment of the present invention.

FIG. 1 illustrates distributed communications environment 100 which includes network devices 130 and telecommunication devices 110a, 110b, 110c, and 110d, as well as transmission tower 120, all interconnected over network 150.

Network 150 connects all transmitting, receiving and operational telecommunication devices. Network 150 is illustrated as including public switched telephone network (PSTN 140), which consists of telephone lines, fiber optic cables, microwave transmission links, cellular networks, communications satellites, undersea telephone cables, and other devices, all inter-connected by switching centers, thus allowing any telephone in the world to communicate with any other. Network 150 also includes mobile switching center (MSC 160) which provides a connection from mobile service network to PSTN 140. Depicted in network 150 is network devices 130, which represents multiple components of the communications environment and network, supporting the handling of communications.

Network 150 can be, for example, a local area network (LAN), a wide area network (WAN), the Internet, a cable network, a fiber optic network, or a wireless network or any other network or combinations of networks that connect the telecommunication devices of distributed communications environment 100. In general, network 150 can be any combination of connections and protocols that will support communications between network devices 130, transmission tower 120 and telecommunication devices 110a, 110b, 110c, and 110d.

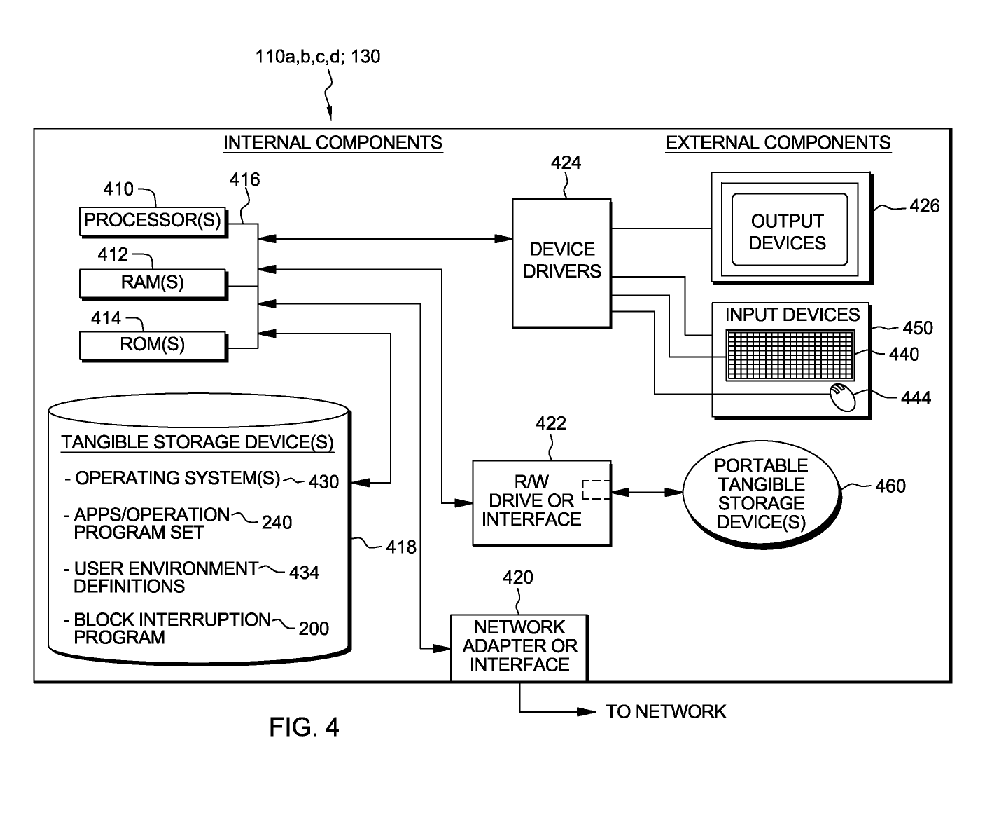

Network devices 130 represents the network servers, databases and other devices that support the interconnection of mobile and landline communications. This includes, but is not limited to, base station controllers (BSCs), that handle allocation of radio channels, receive measurements from the mobile phones, and control handovers from BTS to BTS; base transceiver stations (BTS), which include the equipment for transmitting and receiving radio signals; transcoders that handle coding differences between mobile and terrestrial networks; and databases for all the sites, including information such as carrier frequencies, frequency hopping lists, power reduction levels and receiving levels for cell border calculations. These devices may be supported by one or more computers, such as mainframe computers, mid-range computers, thin clients, thick clients, laptop computers, personal computers (PCs), desktop computers, or any programmable electronic device capable of supporting communication transmission, communication identification, routing, propagation, and other communications services. These computers support and enable communications to and from telecommunication devices such as 110a, 110b, 110c, and 110d, via network 150, within distributed communications environment 100. Network devices 130 represents one or more computing devices and other hardware used to identify users belonging to the service provider, identify communication destinations, such as other communications recipients, receive initiated calls from network 150, manage communication records and propagate communications to transmission tower 120 to be transmitted to call recipients. The computing devices that are included in network devices 130 may include internal and external hardware components, as depicted and described in further detail with respect to FIG. 4.

Transmission tower 120 is one of a plurality of transmission towers used to support cellular phone communications and data transmission to mobile devices. Transmission tower 120 receives communications from telecommunication devices 110a, 110b, 110c, and 110d, and ultimately connects the communication transmission to network 150 that in turn may submit the communications to network devices 130 and transmission tower 120 or another transmission tower, to transmit the communication to intended communications devices, such as telecommunication device 110a, for example.

FIG. 1 also depicts telecommunication devices 110a, 110b, 110c, and 110d. In an exemplary embodiment of the present invention, telecommunication devices 110a, 110b, 110c and 110d, can be a smart-phone or personal digital assistant (PDA). Alternatively, telecommunication devices 110a, 110b, 110c, and 110d, can also be properly configured, network connected computing devices such as, but not limited to laptop computers, netbook computers, desktop computers, or tablet computers, using voice over Internet Protocol (VoIP) technology, which uses Internet Protocol networks, such as the Internet, for transmission of communications. Telecommunication devices 110a, 110b, 110c, and 110d can be any programmable digital device capable of transmitting and receiving a plurality of communication types, with other telecommunication devices, over network 150. The communication types may include, but are not limited to: audio communications (calls), SMS messages, emails, call-waiting alerts, caller-ID alerts, alarms and alerts from applications, and other notifications.

In one embodiment, telecommunication device 110a can be a smart phone that can receive and send many forms of communication, such as telephone calls, short message service (SMS) messages, emails, pictures, and alert notifications from applications running on or connected wirelessly to telecommunication device 110a. Telecommunication device 110a, utilizing one or more carrier services, can initiate or receive phone calls with one or more other telecommunication devices, such as device 110b, which can be another smart phone, for example. Telecommunication devices 110a, 110b, 110c, and 110d, can send and receive SMS messages that are typically 160 characters or less in length and are generally referred to as “text messages”.

Telecommunication device 110a, for example, is also capable of sending and receiving emails that includes content generally longer than 160 characters and can include pictures, images, attachments, and links to web pages or web sites. Applications running on telecommunication devices, such as telecommunication device 110a, for example, are capable of initiating alerts and notifications to bring events or information to the attention of a user. Each type of communication received by telecommunication device 110a produces an alarm or alert sound and is often accompanied by a short vibration and/or a visual display. The alarm, alert, telephone call, call waiting notice, email, email notice, text message, text message received notice, application alarm, or any other notice received by telecommunication devices, such as telecommunication devices 110a, 110b, 110c, and 110d, that produces an audible sound, a visual display on the screen or a vibration of the device, will be inclusively referred to hereafter, as an incoming communication or collectively as incoming communications.

In some cases telecommunication device 110a can be configured to suppress sounds, and/or vibration alerts, but it is generally beneficial to the user to be made aware of pending or arriving communications and users that forget to adjust suppressed settings back to their normal state may experience lost or delayed awareness of received communications.

Embodiments of the present invention recognize that telecommunication devices such as telecommunication devices 110a, 110b, 110c, and 110d, having alert settings enabled, do not alter their operational activities when the device is party to a conference call. Being party to a conference call refers to when the telecommunication device, for example device 110a, is connected to an in-progress telephone call in which there are three or more unique voices. Therefore, any incoming call, SMS message, email or any alarm or alert from an application running on the telecommunication device, will continue to sound and/or display alerts that can be distracting, disabling and annoying to the user on the conference call, and the user may miss some content of the call resulting from alarm interruptions.

In various embodiments of the present invention, telecommunication devices 110a, 110b, 110c, and 110d can each respectively execute programmable instructions and communicate with other computing devices and network devices 130 via transmission tower 120 and network 150. Telecommunication devices 110a, 110b, 110c, and 110d include block interruption program 200 which executes locally on telecommunication devices 110a, 110b, 110c, and 110d and can determine when a user is on a conference call, block incoming communications that would interrupt the conference call, store information regarding communications received while the blocking function is enabled and present the information regarding the communications received during the conference call once the conference call is concluded.

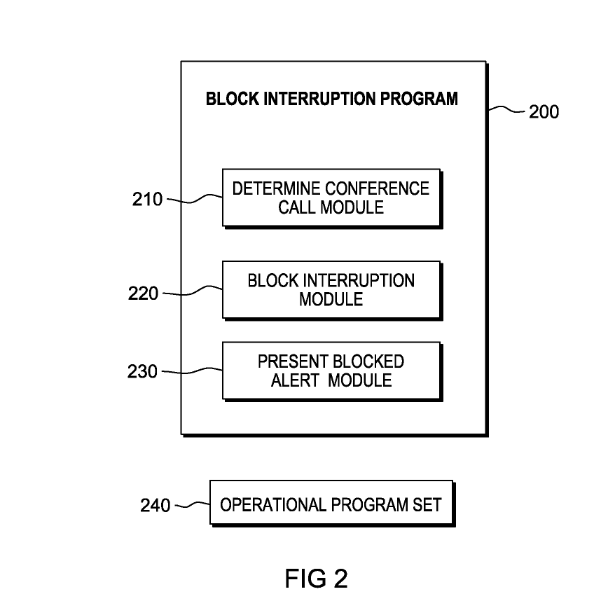

FIG. 2 is a block diagram depicting the program modules of a block interruption program 200, in accordance with an embodiment of the present invention. Block interruption program 200 is an application installed and run on telecommunication devices 110a, 110b, 110c, and 110d and includes a determine conference call module 210, a block interruption module 220 and a present blocked alert module 230, as functional module components of block interruption program 200. FIG. 2 also depicts an operational program set 240 which represents other programs that may be installed on telecommunication devices 110a, 110b, 110c, and 110d that support the operational and optional capabilities of the telecommunication devices.

In an embodiment of the present invention, block interruption program 200 is a program installed on a communications device, such as telecommunications device 110a, and blocks incoming communications alerts, alarms and/or signals that would interrupt a conference call in-progress on telecommunication device 110a. Block interruption program 200 includes modules that determine if a telecommunication device, such as device 110a is party to a conference call and if so, enables interruption blocking, obtains information about an incoming communication during a conference call and presents the communications received during the conference call, once the conference call has ended.

Determine conference call module 210 detects and analyzes the voices on an active phone call made from or received by the communications device, and determines if there are three or more unique voices. If three or more unique voices are detected, then a conference call is confirmed. Current voice recognition technology is fully capable of determining uniqueness of detected voices. In many cases, voice recognition is accomplished by first entering a sampling of a user's voice and storing this analyzed voice sample in a profile, then matching subsequent voice samples against the stored voice profile data to transform spoken words into written text. Examples of this type of software include “Dragon NaturallySpeaking 12 Premium” (a product of Nuance Communications, Incorporated) and “Windows Speech Recognition” program, which comes bundled with Windows Vista and Windows 7 operating systems (Windows is a registered trademark of Microsoft Corporation in the United States and other countries). In embodiments of the present invention, voice samples are taken by determine conference call module 210 during the initial part of a call and the analytical differences of the voiceprints are compared to determine if there are three or more unique voices on the call. A voiceprint is determined by the physiological characteristics of the components that produce an individual's voice, which can include the size and shape of the airway, cavities and the size and shape of the larynx and its components. Voice sounds or speech are produced when these components and the movements of the jaw, tongue, and larynx work together and the sounds that are produced resonate in the nasal cavities. The acoustic pattern produced can be as unique as a fingerprint, and can be used to distinguish one speaker from another.

Speech recognition software is used to identify specific spoken words and typically transform the spoken words into text within a document or to execute a command. Vibrations from spoken words are translated into digital data by an analog-to-digital converter (ADC) and can be analyzed by a programmable telecommunication device running speech recognition software, to filter and normalize the digital data and determine the frequency bands that compose the digital data. In some cases the data can be broken down into very small segments that might represent a hundredth or a thousandth of a second of sound. The speech recognition program then matches the small segments of digital data frequencies to known phonemes for a specific language. Phonemes are the smallest representation of sounds that humans make. There are roughly 40 phonemes in the English language and the program matches the spoken segments to the known phonemes and examines each phoneme in the context of the other phonemes around them. The speech recognition program then compares the contextual phoneme combinations to a large library of known words (other models may also be applied) and determines what the spoken word(s) are.

In an embodiment of the present invention, determine conference call 210 also makes use of speech recognition technology to identify specific keywords spoken during the initial phase of a call that indicates that the call is a conference call. An example, but not an exhaustive list, of keywords that may indicate that a telecommunication device is connecting to a conference call include: conference, teleconference, call number, conference number, “ . . . other parties join”. Some or all of these words, or other words, may be identified by speech recognition technology, used by determine conference call module 210, running on the telecommunication device, such as device 110a, so that determination of an occurrence of a word or combination of words spoken on a call, indicates to determine conference call module 210 that the call is in fact a conference call.

In embodiments of the present invention, determine conference call module 210 of block interruption program 200, uses voice recognition/identification technology to determine if there are three or more unique voices identified on a user's call. In addition, determine conference call module 210 may also use speech recognition technology to detect selected or predefined words or keywords that indicate that the call on telecommunication device 110a, for example, is a conference call. Detection of keywords spoken on the call or determining the presence of three or more unique voices confirms that the user is participating in a conference call and determine conference call module 210 initiates block interruption module 220. If determine conference call module 210 did not determine that three or more unique voices were on the call, then block interruption module 220 is not initiated.

Block interruption module 220 prevents incoming communications, alerts and alarms from sounding or displaying and obtains information about the incoming communication, alert or alarm and stores the information for later access by the user. By blocking the incoming communication alert, the conference call in-progress is not interrupted. Determine conference call module 210 continues to run and samples the voices and determines if the call has ended by determining that there is no voice activity, or if there are only two unique voices on the call, indicating that the call is no longer a conference call. Once the call has ended, present blocked alert module 230 alerts the user to the information about incoming communications while the conference call was in progress.

Operational program set 240 represents the programs and applications on the telecommunication device that support the operational functions of the device, such as the kernel program, which manages the drivers and processes for the hardware in the device, the middleware program(s) which includes software libraries that enable software applications such as web browsing and messaging, for example. Operational program set 240 also includes application execution environment (AEE) programming interfaces used by developers so that custom or application specific programs can be run on the device, and includes user-installed applications, which are typically downloaded to the telecommunication device. Operational program set 240 also includes a user interface framework which presents the graphical layouts and input selections that are seen on the display screen.

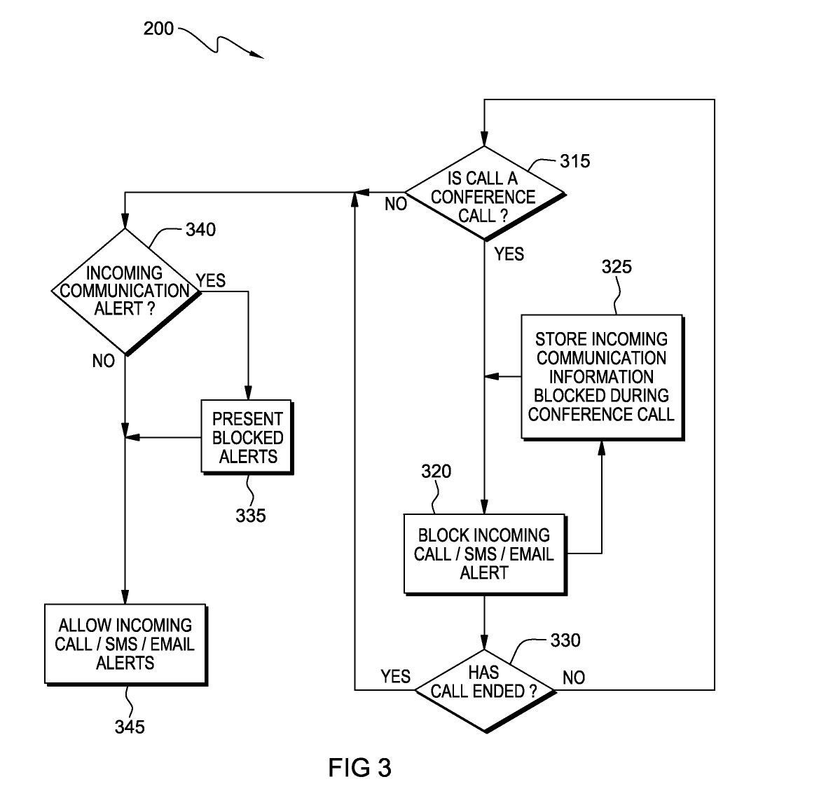

FIG. 3 is a flowchart illustrating the steps of block interruption program 200 in accordance to an embodiment of the present invention. Block interruption program 200 runs as a background program resident on a telecommunication device and monitors if the telecommunication device is party to a conference call. If the telecommunication device is party to a call, block interruption program 200 determines if the call is a conference call (step 315) by using voice recognition/identification technology to determine if there are three or more unique voices on the call. Alternatively, block interruption program 200 uses speech recognition technology to determine if specific key words are spoken on the call, indicating a conference call is about to begin. In one embodiment, monitoring the telecommunication device to determine whether the call is a conference call is performed by determine conference call module 210 of block interruption program 200.

If the call is determined to not be a conference call (step 315, no branch) then block interruption program 200 checks if any received incoming communications information needs to be retrieved and presented, and allows incoming communications and alerts (step 345). Determining that the call is a conference call, (step 315, yes branch) block interruption program 200 initiates the blocking of incoming calls, call waiting alerts, SMS messages, emails, alarms or any other audio, visual or vibration alerts on the telecommunication device (step 320). While the blocking of incoming communications is enabled, the information associated with an incoming communication alert is stored to be presented after the conference call has ended (step 325), and block interruption program 200 continues to monitor the call to determine if the call has ended (step 330). In one embodiment of the present invention the end of the call is determined by block interruption program 200 when voices are no longer detected for a period of time that is configurable or a default setting or the end of the call may be determined by other indicators, signals or lack of signals.

Block interruption program 200, determining that the call has not ended (step 330, no branch), continues to monitor the call to determine if the call is still a conference call (loop to step 315). In one embodiment, this may be done by determining that three or more unique voices can be detected on the call. In other embodiments, if only two unique voices are detected on the call, block interruption program 200 may determine that the call is no longer a conference call (step 315, no branch), and check for blocked incoming communication alerts (step 340), and if incoming communications have been blocked (step 340, yes branch), present the blocked communications (step 335), and allow subsequent incoming calls, messages, alarms and alerts to be received (step 345). If no incoming communications were blocked (step 340, no branch), then block interruption program 200 terminates the blocking of incoming communications and allows incoming calls, SMS, emails, alarms and alerts (step 345). In yet other embodiments, block interruption program 200 may have a configurable period of time in which it delays detecting unique voices on the call to determine if the call is no longer a conference call, or block interruption program 200 may present a silent symbol to confirm if the conference call has ended, before the blocking of incoming communications is terminated. In one embodiment the blocking of incoming communications and storing of information associated with the blocked incoming communications are performed by block interruption module 220 of block interruption program 200.

During a conference call, block interruption program 200 monitors the call to determine if the call has ended and determines that the call has ended (step 330, yes branch), block interruption program 200 checks if there were incoming communications that were blocked during the conference call (step 340) and presents the incoming communication information and terminates the blocking of incoming communications (step 340, yes branch), or otherwise (step 340, no branch) terminates the blocking of incoming communications and allows incoming calls, SMS messages, emails, alarms and alerts to be received (step 345). In one embodiment of the present invention, checking for incoming communications that were blocked during the conference call and presenting the blocked incoming communication information is performed by present blocked alert module 230 of block interruption program 200.

In an alternative embodiment of the present invention, block interruption program 200 may use a list of allowable alerts, predetermined and input to the telecommunication device, for example, device 110a, such that while telecommunication device 110a is party to a conference call, incoming communication alerts that are included on the list of allowable alerts, are allowed and are not blocked by block interruption program 200. This allows for the case in which emergency contact by one or more specific sources is always necessary.

In an exemplary embodiment of the present invention, telecommunication device 110a is used to initiate a telephone call and block interruption program 200 uses voice recognition/identification technology to determine that there are more than three unique voices on the call and therefore determines the call to be a conference call (step 315, yes branch). In an alternative embodiment, telecommunication device 110a may have been used to connect to a conferencing center and may have been greeted by an automated voice response that indicates the telecommunication device has connected to the conferencing center and asks for entry of a pass code to join the conference. Block interruption program 200 uses speech recognition technology to identify key words, such as “conferencing center” and “pass code” and “join the conference”, some of which may be adequate to match with predetermined key words and confirm that the user is on a conference call.

Block interruption program 200 begins blocking incoming communications (step 320) and if any incoming communication is received, all audible, visible or vibrating alerts are blocked, however, the information associated with the blocked incoming communication is stored (step 325), to present once the conference call has ended.

The telecommunication device remains a party to the conference call and block interruption program 200 continues to monitor the call to determine if the call has ended (step 330), which, in one embodiment may be determined by detecting no voices on the call for a designated or default period of time. Block interruption program 200 determines that the call has ended (step 330, yes branch) and determines the several incoming communications were blocked during the conference call (step 340, yes branch). The information associated with the incoming communications that were blocked during the conference call is presented (step 335) and block interruption program 200 terminates the blocking of incoming communications (step 345).

If block interruption program 200 does not detect a conference call (step 315, no branch), then incoming communications are allowed. In the case where the user was on a conference call and the call continues, however, block interruption program 200 determines that only two unique voices (less than three unique voices) remain on the call (step 315, no branch), and block interruption program 200 determines if there is information associated with incoming communication that were blocked during the conference call. Block interruption program 200 determines that there is no blocked communication information (step 340, no branch) and terminates the blocking of incoming communications (step 345) and allows incoming communications.

FIG. 4 is a block diagram of components of a programmable computing device, such as network devices 130 and telecommunication devices 110a, 110b, 110c, and 110d, in accordance with an embodiment of the present invention. It should be appreciated that FIG. 4 provides only an illustration of one implementation and does not imply any limitations with regard to the environments in which different embodiments may be implemented. Many modifications to the depicted environment may be made.

In an exemplary embodiment, network devices 130 and telecommunication devices 110a, 110b, 110c, and 110d, include one or more processors 410, one or more computer-readable RAMs 412, one or more computer-readable ROMs 414, and one or more computer-readable tangible storage devices 418 on one or more buses 416. One or more operating systems 430, one or more apps or operational program set 240, one or more user environment definitions 434, and block interruption program 200 are stored on the one or more computer-readable tangible storage devices 418 for execution by one or more of the processors 410 via one or more of the RAMs 412 (which typically include cache memory). In the illustrated embodiment, the computer-readable tangible storage device(s) 418 are computer-readable magnetic disk storage device(s) of internal hard drive(s). Alternatively, the computer-readable tangible storage device(s) 418 is a semiconductor storage device, such as a micro secure digital high capacity (SDHC) card.

Network devices 130 and telecommunication devices 110a, 110b, 110c, and 110d, also include a read/write (R/W) interface 422, for example, a USB port, to read from and write to external computing devices or one or more portable computer-readable tangible storage devices such as a magnetic disk, optical disk or semiconductor storage device. The apps (applications)/operational program set 240 block interruption program 200 and the user environment definitions 434 can be stored on the external computing devices or one or more of the portable computer-readable tangible storage devices, such as portable tangible storage device(s) 460, read via the R/W interface 422 and loaded onto the computer-readable tangible storage device 418.

Network devices 130 and telecommunication devices 110a, 110b, 110c, and 110d, also include a network adapter or interface 420, such as a TCP/IP adapter card or wireless communication adapter (such as a 4G wireless communication adapter using OFDMA technology, for example). The apps and operational program set 240, the user environment definitions 434 and block interruption program 200 can be downloaded to network devices 130 and telecommunication devices 110a, 110b, 110c, and 110d, from an external computer or external storage device via a network (for example, the Internet, a local area network, a wide area network, or a wireless network, such as a 4G network) and network adapter or interface 420. From the network adapter or interface 420, the apps and operational program set 240, the user environment definitions 434 and block interruption program 200, are loaded into computer-readable tangible storage device 418. The network may comprise copper wires, optical fibers, wireless transmission, routers, firewalls, switches, gateway computers and/or edge servers.

Network devices 130 and telecommunication devices 110a, 110b, 110c, and 110d, also include output devices 426, which can include a display screen for visual output, a speaker for audio output, and other output devices (telecommunication devices 110a, 110b, 110c, and 110d may include a vibrating capability to signal a silent alert, and signals to indicate location). Network devices 130 and telecommunication devices 110a, 110b, 110c, and 110d also include input devices 450 which can include keyboard 440 with hard buttons or a touch screen keyboard, and pointing device 444, such as a mouse or touch screen. Input devices 450 can also include, for example, a camera, a microphone for receiving audio input, and sensors such as a magnetic flux detector an accelerometer or a global positioning system (GPS) feature (not shown). Network devices 130 and telecommunication devices 110a, 110b, 110c, and 110d also include device drivers 424 to interface to input devices 450 and output devices 426. The device drivers 424, R/W interface 422 and network adapter or interface 420 comprise hardware and software (stored in computer-readable tangible storage device 418 and/or ROM 414).

It should be appreciated that FIG. 4 provides only an illustration of one implementation and does not imply any limitations with regard to the environments in which different embodiments may be implemented. Many modifications to the depicted environment may be made.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Based on the foregoing, a computer system, method and program product have been disclosed for selecting a user environment based on a device cover. However, numerous modifications and substitutions can be made without deviating from the scope of the present invention. Therefore, the present invention has been disclosed by way of example and not limitation.

1. A method for blocking an alert of an incoming communication external to an in-progress conference call, the method comprising:
a telecommunication device determining that the telecommunication device is party to a conference call, based on the content of the conference call;
the telecommunication device receiving an incoming communication external to the conference call while the telecommunication device is party to the conference call;
the telecommunication device blocking an alert of the incoming communication in response to determining that the telecommunication device is party to the conference call;
the telecommunication device determining that the conference call has concluded; and
the telecommunication device presenting the blocked alert.

2. The method in accordance with claim 1, wherein the step of the telecommunication device determining that the conference call has concluded further includes:
determining that the conference call has concluded by detecting less than three unique voices on the conference call.

3. The method in accordance with claim 1, wherein the step of the telecommunication device determining that the telecommunication device is party to the conference call, further includes detecting three or more unique voices on the conference call.

4. The method in accordance with claim 1, wherein the step of the telecommunication device determining that the telecommunication device is party to a conference call, further includes identifying a one or more keywords that indicates the telecommunication device is party to the conference call.

5. The method in accordance with claim 1, wherein the step of the telecommunication device determining that the telecommunication device is party to a conference call, further includes the telecommunication device receiving manual input of being party to a conference call.

6. The method in accordance with claim 1, wherein the incoming communication is from a source internal to the telecommunication device.

7. The method in accordance with claim 1, wherein the step of the telecommunication device receiving an incoming communication external to the conference call while the telecommunication device is party to the conference call, further includes identifying an allowable incoming communication alert from an allowable alert list and receiving the allowable incoming communication alert.

8. A computer program product for blocking an alert of an incoming communication external to an in-progress conference call, the computer program product comprising:
one or more computer-readable storage media and program instructions stored on the one or more computer-readable storage media, the program instructions comprising:
program instructions to determine that a telecommunication device is party to a conference call, based on the content of the conference call;
program instructions to receive an incoming communication external to the conference call while the telecommunication device is party to the conference call;
program instructions to block an alert of the incoming communication in response to determining that the telecommunication device is party to the conference call;
program instructions to determine that the conference call has concluded; and
program instructions to present the blocked alert.

9. The computer program product of claim 8, wherein the program instructions for determining that the conference call has concluded includes detecting less than three unique voices on the conference call.

10. The computer program product of claim 8, wherein the program instructions for determining that the telecommunication device is party to the conference call, further includes detecting three or more unique voices on the conference call.

11. The computer program product of claim 8, wherein the program instructions for determining that the telecommunication device is party to the conference call, further includes identifying a one or more keywords that indicates the telecommunication device is party to the conference call.

12. The computer program product of claim 8, wherein the program instructions for determining that the telecommunication device is party to a conference call, further includes the telecommunication device receiving manual input of being party to a conference call.

13. The computer program product of claim 8, wherein the incoming communication is from a source internal to the telecommunication device.

14. The computer program product of claim 8, wherein the telecommunication device receiving an incoming communication external to the conference call while the telecommunication device is party to the conference call, further includes identifying an allowable incoming communication alert from an allowable alert list and receiving the allowable incoming communication alert.

15. A computer system for blocking an alert of an incoming communication external to an in-progress conference call, the computer system comprising:
one or more computer processors;
one or more computer-readable storage media;
one or more computer-readable tangible storage devices;
program instructions stored on the computer-readable storage media for execution by at least one of the one or more processors, the program instructions comprising:
program instructions to determine that a telecommunication device is party to a conference call, based on the content of the conference call;
program instructions to receive an incoming communication external to the conference call while the telecommunication device is party to the conference call;
program instructions to block an alert of the incoming communication in response to determining that the telecommunication device is party to the conference call;
program instructions to determine that the conference call has concluded; and
program instructions to present the blocked alert.

16. The computer system of claim 15, wherein the program instructions determine that the conference call has concluded by detecting less than three unique voices on the conference call.

17. The computer system of claim 15, wherein the program instructions determine that the telecommunication device is party to the conference call by detecting three or more unique voices on the conference call, or by identifying a one or more keywords that indicates the telecommunication device is party to the conference call or both.

18. The computer system of claim 15, wherein the program instructions determine that the telecommunication device is party to the conference call by the telecommunication device receiving manual input of being party to a conference call.

19. The computer system of claim 15, wherein the incoming communication is from a source internal to the telecommunication device.

20. The computer system of claim 15, wherein the program instructions of the telecommunication device receiving an incoming communication external to the conference call while the telecommunication device is party to the conference call includes identifying an allowable incoming communication alert from an allowable alert list and receiving the allowable incoming communication alert.
